(19) United States
(12) Patent Application Publication
(10) Pub. No.: US 2010/0103526 A1
(43) Pub. Date: Apr. 29, 2010

(54) POLARIZATION MAINTAINING OPTICAL INTEGRATION

(76) Inventors: Gary E. Nothhard, Hilton, NY (US); Barry D. Silverstein, Rochester, NY (US)

Correspondence Address: J. Lanny Tucker;Patent Legal Staff, Eastman Kodak Company, 343 State Street, Rochester, NY, 14650-2201, US

(21) Appl. No.: 12/259,326

(22) Filed: Oct. 28, 2008

(51) Int. Cl. G02B 27/10

(52) U.S. Cl. 359/618

(57) ABSTRACT

An optical integrating bar is square or rectangular in cross-section having first and second axes each perpendicular to opposite sides of the cross-section. Source light beams are transmitted to the optical integrating bar in a direction perpendicular to the cross-section. The source light beams exhibit first, second, or first and second polarization states that are orthogonal to each other. The first, second, or first and second polarization states are aligned or substantially aligned with the first, second, or first and second axes of the optical integrating bar, respectively, when the source light beams are transmitted to the optical integrating bar. In this manner, combined light exiting the optical integrating bar maintains or substantially maintains the polarization of each of the source light beams.

### CROSS-REFERENCE TO RELATED APPLICATION(S)

This application is related to prior U.S. patent application Ser. No. 12/036,385, filed Feb. 25, 2008, with an Attorney Docket Number of 94569, and is also related to U.S. patent application Ser. No. ______, filed concurrently herewith, with an Attorney Docket Number of 95298 and a title of “Etendue Maintaining Polarization Switching System and Related Methods” by Barry Silverstein et al. The entire disclosure of docket 95298 is hereby incorporated herein by reference in its entirety.

### FIELD OF THE INVENTION

The present invention relates to optical integrating bars.

### BACKGROUND

With respect to FIG. 1, a traditional use of an optical integrating bar 1 is for it to receive incoming non-uniform intensity light beams 2 of typically converging light. In the example of FIG. 1, the input face 3 is illuminated by multiple spots of light, i.e., the non-uniform intensity light beams 2. When the incoming beams of light 2 enter the optical integrating bar 1, the incoming light is subsequently reflected on the side walls of the integrating bar by total internal reflection or conventional reflection. The varying input angles of the light, as shown converging have differing numbers of reflections and paths through the integrating bar. It is commonly understood that by controlling the angular input, length and dimensions of the bar with respect to the light beam parameters, that the output light will be spatially and angularly mixed compared with the input beam. With enough path length and bounces, the integrated output light 5 can be made significantly uniform in intensity, as shown at output face 4 of the integrating bar 1.

Beyond this traditional use of optical integrating bars, additional uses are desirable.

### SUMMARY

The above-described desire is addressed and a technical solution is achieved in the art by systems and methods for polarization maintaining optical integration, according to various embodiments of the present invention.

In some embodiments of the present invention, source light is transmitted to an optical integrating bar, the source light including light having linear or substantially linear polarization in or substantially in a first polarization state or light having polarization in or substantially in the first polarization state and in or substantially in a second polarization state orthogonal and substantially orthogonal to the first polarization state. The optical integrating bar is or substantially is square or rectangular in cross-section. The cross-section has first and second axes each perpendicular or substantially perpendicular to each other and each perpendicular or substantially perpendicular to opposite one-dimensional sides of the cross-section. The source light is transmitted to the optical integrating bar in a direction nominally perpendicular to an input face of the optical integrating bar. The input face is parallel or substantially parallel to the cross-section. The first, second, or first and second polarization states are aligned or substantially aligned with the first, second, or first and second axes of the optical integrating bar, respectively, when the source light beams are transmitted to the optical integrating bar by the transmitting step. In this way, polarization of the source light is substantially maintained even after it is integrated and the uniformity of its intensity has been improved by the integrating bar.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates an existing optical integrating bar;

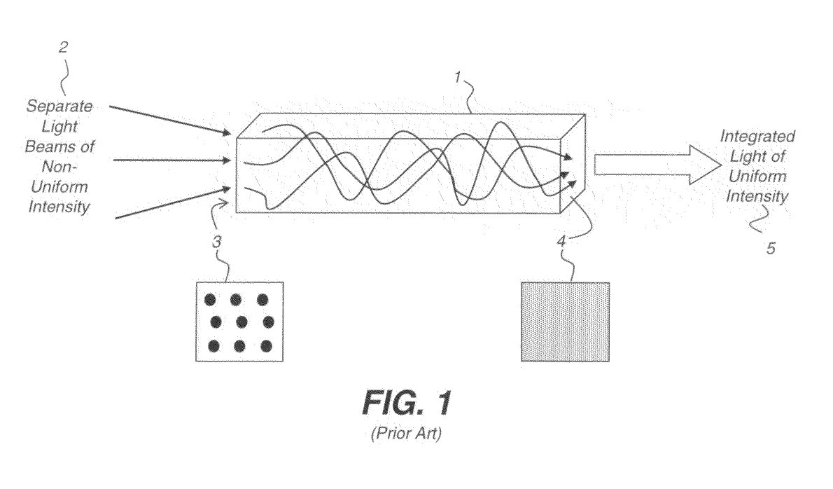

FIG. 2 illustrates the transmission of source light to an optical integrating bar in a manner that aligns or substantially aligns the polarization state(s) of the source light with the axes of the optical integrating bar in order to maintain or substantially maintain the polarization state(s), according to an embodiment of the present invention; and

FIG. 3 illustrates an optical system utilizing the technique of FIG. 2, according to an embodiment of the present invention.

It is to be understood that the attached drawings are for purposes of illustrating the concepts of the invention and may not be to scale.

### DETAILED DESCRIPTION

Various embodiments of the present invention pertain to maintaining or substantially maintaining the polarization of source light while improving uniformity of the intensity of the source light. In this regard, embodiments of the present invention involve directing source light beams having linear polarization states towards an optical integrating bar in a manner that aligns or substantially aligns the polarization state(s) of the source light beams with the axes of the optical integrating bar. If such alignment is performed, the combined light output by the optical integrating bar will exhibit or substantially exhibit the polarization states of the source light beams, while also exhibiting improved intensity uniformity.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. Further, it should be noted that, unless otherwise explicitly noted or required by context, the word “or” is used in this disclosure in a non-exclusive sense. Further still, although this description often uses the term “light”, one skilled in the art will appreciate that other forms of radiation may be used in various embodiments of the present invention.

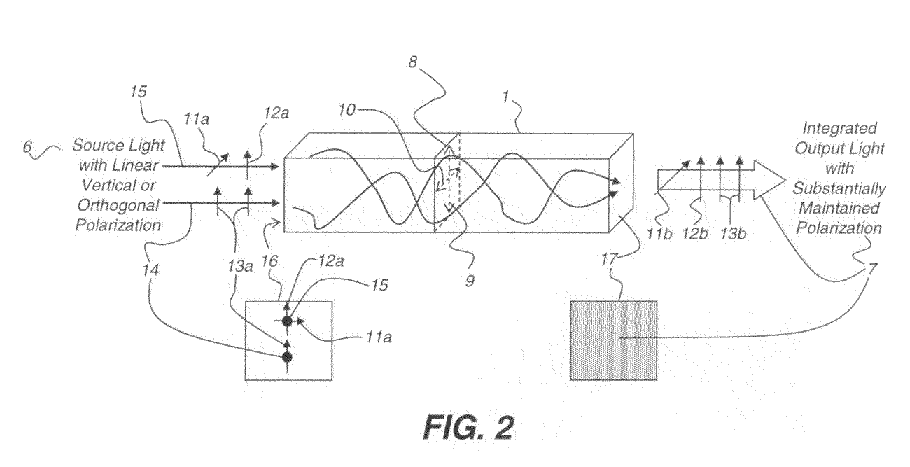

FIG. 2 illustrates the transmission of source light to an optical integrating bar in a manner that aligns or substantially aligns the polarization state(s) of the source light with the axes of the optical integrating bar in order to maintain or substantially maintain the polarization state(s), according to an embodiment of the present invention. In particular, source light 6, including one or more separate source light beams (14, 15, for example) are transmitted to an optical integrating bar 1. For simplicity, light beams 14 and 15 are each shown as a ray. However, they must actually contain an angular cone in order for intensity uniformization to be functional.

Each source light beam 14, 15 includes light having linear polarization in a first polarization state or light having the first polarization state and a second polarization state orthogonal to the first polarization state. In the particular example of FIG. 2, source light beam 14 includes light having uniform polarization in a first polarization state 13a. Source light beam 15 includes light having polarization in the first polarization state 12a and the second polarization state 11a. The second polarization state 11a is orthogonal to the first polarization state 12a, 13a.

The optical integrating bar 1, in this example, is square in cross-section 8. However, one of ordinary skill in the art will appreciate that optical integrating bars may have a rectangular cross-section and may tapered such that the input face and output face are not the same size or proportion. The cross-section 8 has a first axis 9 extending vertically in FIG. 2 and a second axis 10 extending horizontally in FIG. 2. The first axis 9 is perpendicular to the opposing one-dimensional vertical sides of the cross-section 8, and the second axis 10 is perpendicular to the opposing one-dimensional horizontal sides of the cross-section 8. The vertical and horizontal sides of the cross-section 8 are referred to herein as one-dimensional to distinguish them from the two-dimensional faces of the cross-section 8.

The optical integrating bar includes an input face 16 and an output face 17. The input face 16 and the output face 17 are parallel or substantially parallel to the cross-section 8. As illustrated in the embodiment of FIG. 2, the source light beams 14, 15 are transmitted to the optical integrating bar 1 in a direction nominally perpendicular to the input face 16. The first polarization state (12a, 13a, for example) and the second polarization state (11a, for example) are aligned or substantially aligned with the first axis 9 and the second axis 10, respectively, of the optical integrating bar when the source light beams 14, 15 are transmitted to the optical integrating bar 1. Consequently, the integrated light output 7 from the optical integrating bar 1 maintains or substantially maintains the polarization of the source light 6. In the example of FIG. 2, the polarization 11a, 12a of source light beam 15 is maintained or substantially maintained in combined output light 7, as represented (for illustration purposes only) by polarization 11b in the second polarization state and polarization 12b in the first polarization state. Also in the example of FIG. 2, the polarization 13a of source light beam 14 is maintained or substantially maintained in combined output light 7, as represented (for illustration purposes only) by polarization 13b in the first polarization state.

So long as the polarization of source light 6 is aligned or substantially aligned with axis 9 or axis 10, such polarization will be maintained or substantially maintained in the combined output light 7. Light from any source may be used provided it is linearly polarized and aligned to the integrating bar as described. It is particularly advantageous to utilize light that is emitted in a polarized state, such as from a laser or array of lasers. By utilizing a source that is already of small etendue and polarized, highly efficient illumination systems may be developed.

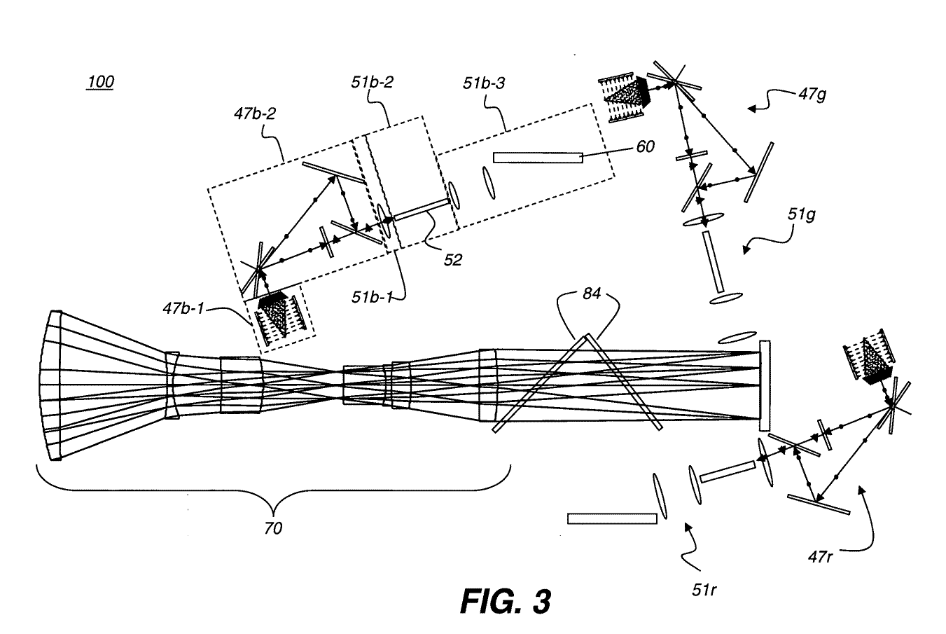

FIG. 3 illustrates an optical system utilizing the technique of FIG. 2, according to an embodiment of the present invention. In particular, FIG. 3 illustrates a projection system 100 described in related U.S. patent application Ser. No. ______, filed concurrently herewith, with an Attorney Docket Number of 95298 and a title of “Etendue Maintaining Polarization Switching System and Related Methods” by Barry Silverstein et al. This reference is hereinafter referred to as the “Silverstein et al. Reference.” The system 100 incorporates etendue maintaining polarization switching systems 47 (47r, 47g, 47b) for each color channel (red, green, blue, respectively, for example), as described in the Silverstein et al. Reference. According to an embodiment of the present invention, the switching systems 47 each comprise an illumination system 47-1 and a switching subsystem 47-2. The illumination system may include one or more lasers or one or more laser arrays.

Associated with each switching system 47r, 47g, 47b, are supporting optics 51r, 51g, 51b, respectively. According to an embodiment of the present invention, each set of supporting optics 51 includes a lens 51-1, an integrating bar 52 (also labeled 51-2), additional lenses and a spatial light modulator 60 (collectively labeled 51-3). According to an embodiment of the present invention, the illumination system 47-1 transmits polarized source light to the switching subsystem 47-2, which interacts with the transmitted source light and outputs light having uniform polarization in a first polarization state or light having polarization in first and second polarization states orthogonal to each other. The output light from switching subsystem 47-2 passes through a lens 51-1 which takes the low angular distribution light from the solid state light source(s) and delivers a more highly angled cone of linearly polarized light to the integrating bar 52 in the manner illustrated with respect to FIG. 2. The output light from switching subsystem 47-2, after it passes through lens 51 -1 may be considered, for example, source light 6 in FIG. 2. The combined, polarization-maintained light output from the integrating bar 52 may be considered, for example, integrated output light 7 in FIG. 2. Such combined, polarization-maintained output light passes through optics 51-3 which adjusts the angular output and size of the light (substantially matches the etendue of the spatial light modulator and projection lens combination) so that the uniform light effectively illuminates spatial light modulator 60. Light exiting the spatial light modulator 60 is combined with other light output from the other spatial light modulators 60 via dichroic plates 84, known in the art. The combined light from dichroic plates 84 are projected by a projection assembly 70, which includes several lenses in a configuration known in the art.

It is to be understood that the exemplary embodiments are merely illustrative of the present invention and that many variations of the above-described embodiments can be devised by one skilled in the art without departing from the scope of the invention. It is therefore intended that all such variations be included within the scope of the following claims and their equivalents.

### PARTS LIST

1 optical integrating bar
7 integrated light output
8 cross-section
9 first axis
10 second axis
11 a second polarization state
11b polarization
12a first polarization state
12b polarization
13a first polarization state
13b polarization
14 light beam
15 source light beam
16 input face
17 output face
47 switching systems
47b switching system
47g each switching system
47r each switching system
51 supporting optics
51b supporting optics
51g supporting optics
51r supporting optics
52 integrating bar
60 spatial light modulator
70 projection assembly
84 dichroic plates
100 projection system

What is claimed is:

1. A method of maintaining or substantially maintaining polarization of light, the method comprising the step of transmitting source light to an optical integrating bar, the source light comprising light having linear or substantially linear polarization in or substantially in a first polarization state or light having polarization in or substantially in the first polarization state and in or substantially in a second polarization state orthogonal or substantially orthogonal to the first polarization state, wherein the optical integrating bar is or substantially is square or rectangular in cross-section, the cross-section having first and second axes each perpendicular or substantially perpendicular to each other and each perpendicular or substantially perpendicular to opposite one-dimensional sides of the cross-section, wherein the transmitting step transmits the source light to the optical integrating bar in a direction nominally perpendicular to an input face of the optical integrating bar, wherein the input face is parallel or substantially parallel to the cross-section, and wherein the first, second, or first and second polarization states are aligned or substantially aligned with the first, second, or first and second axes of the optical integrating bar, respectively, when the source light beams are transmitted to the optical integrating bar by the transmitting step.

2. The method of claim 1, wherein the source light is laser light.

3. The method of claim 1, wherein the source light comprises a single light beam having polarization in the first polarization state or having polarization in the first and second polarization states.

4. The method of claim 1, wherein the source light comprises a plurality of light beams, each light beam having polarization in the first polarization state or having polarization in the first and second polarization states.

5. An optical system comprising:
an illumination system configured to transmit source light;
an optical system configured to interact with the transmitted source light and configured to output light having linear or substantially linear polarization in a first polarization state or light having polarization in the first polarization state and in a second polarization state orthogonal or substantially orthogonal to the first polarization state; and
an optical integrating bar having or substantially having a square or rectangular cross-section having first and second axes each perpendicular or substantially perpendicular to each other and each perpendicular or substantially perpendicular to opposite one-dimensional sides of the cross-section, the optical integrating bar configured to have an input face nominally perpendicular to the output light from the optical system, the input face being parallel or substantially parallel to the cross-section, and the optical integrating bar configured to have its first, second, or first and second axes aligned or substantially aligned with the first, second, or first and second polarization states, respectively, of the output light.

6. The system of claim 5, wherein the illumination system comprises one or more lasers.

7. The system of claim 5, wherein the illumination system comprises one or more laser arrays.
